(19) United States
(12) Patent Application Publication
(10) Pub. No.: US 2024/0203166 A1
(43) Pub. Date: Jun. 20, 2024

(54) AUTOMATED RECOGNITION OF FARE DODGERS

(71) Applicant: ZF Friedrichshafen AG, Friedrichshafen (DE)

(72) Inventors: Daniel Wolf, Friedrichshafen (DE); Sophia Singer, Friedrichshafen (DE)

(73) Assignee: ZF Friedrichshafen AG, Friedrichshafen (DE)

(21) Appl. No.: 18/558,105

(22) PCT Filed: Mar. 28, 2022
(86) PCT No.: PCT/EP2022/058121

§ 371 Date: Oct. 30, 2023

(30) Foreign Application Priority Data
Apr. 30, 2021 (DE) 10 2021 204 321.6
Aug. 17, 2021 (DE) 10 2021 208 979.8

(51) Int. Cl. G07B 15/02; G06V 40/10

(52) U.S. Cl. CPC G07B 15/02; G06V 40/103

(57) ABSTRACT

A system is configured for recognizing persons using a means of passenger transport (101) without a ticket. The system includes a ticket detection system (103, 105) configured to detect the tickets of persons boarding and alighting the means of transport (101). The system also includes a person detection system and a comparison means, the person detection system configured to detect persons independently of their tickets when they board and alight the means of transport. The comparison means is configured to compare a number of tickets detected by the ticket detection system (103, 105) with a number of persons detected by the person detection system.

### RELATED APPLICATIONS

This application claims the benefit under 35 U.S.C. § 371 as a U.S. National Phase Application of application no. PCT/EP2022/058121, filed on 28 Mar. 2022, which claims benefit of German Patent Application no. 10 2021 204 321.6, filed on 30 Apr. 2021, and German Patent Application No. 10 2021 208 979.8, filed on 17 Aug. 2021, the contents of which are hereby incorporated herein by reference in their entireties.

### FIELD OF THE DISCLOSURE

The invention relates to a system and method for automated recognition of fare dodgers.

### BACKGROUND

So-called CiCo and BiBo systems and combinations thereof are known from the prior art. These systems are used to electronically detect the tickets of passengers in means of passenger transport. A BiBo system is described in DE 10 2007 014 528 A1.

U.S. Pat. No. 2,007,299 722 A2 discloses a method for the automated detecting of the use of chargeable means of passenger transport. The system is used to charge a fare. A transmitter is arranged in the area of the means of transport. This sends out data telegrams in the sense of unidirectional communication, which are received and processed by a passenger's end device.

### SUMMARY

The task underlying the invention is to improve ticket detection systems for means of passenger transport known from the prior art. In particular, it should be possible to recognize fare dodgers, i.e., persons who use the means of passenger transport without a ticket. This task is solved by an arrangement according to claim 1 and a method according to claim 8. Preferred embodiments are contained in the dependent claims and result from the following description.

The arrangement according to the invention is used to recognize fare dodgers, i.e., persons who do not have a ticket. It comprises a ticket detection system. This refers to an arrangement which is configured to detect the tickets of persons boarding the means of passenger transport and alighting the means of passenger transport. One of the above-described systems known from the state of the art for the electronic detection of tickets is suitable as a ticket detection system.

A ticket detection system that detects people on the basis of their tickets is not able to recognize fare dodgers. According to the invention, a person detection system is therefore provided as a supplement to the ticket detection system. This refers to an arrangement that is configured to detect persons boarding the means of passenger transport and alighting the means of passenger transport independently of their ticket. In particular, the person detection system is able to detect passengers who do not have a ticket upon boarding and alighting. The person detection system thus also detects fare dodgers.

According to the invention, the arrangement also comprises a comparison means. This is configured to compare a number of tickets detected by the ticket detection system and a number of persons detected by the person detection system. The number of tickets detected by the ticket detection system is a count of the number of tickets detected at the time of each person's boarding that have not yet been detected at the time of alighting. The number of tickets detected is therefore the difference between the number of tickets detected when the person boards and the number of tickets detected when the person alights.

Accordingly, the number of persons detected by the person detection system is a count of the number of persons detected upon boarding who have not yet been detected upon alighting. This number is the difference between the number of people detected upon boarding and a number of people detected upon alighting.

A difference between the two numbers corresponds to the number of fare dodgers in the means of passenger transport. If the difference is zero, i.e., if the two numbers compared by the comparison means match, then it can be assumed that no fare dodgers are present in the means of passenger transport. With a non-zero difference, targeted passenger checks can be carried out to convict fare dodgers.

The ticket detection system is preferably further designed to charge the detected tickets. Specifically, this involves detecting an identifier when a person boards or alights. This is an identifier that is assigned to the respective person and/or the person's ticket. The identifier is in turn assigned to an account from which a suitable amount of a means of payment is debited.

In a further preferred embodiment, the amount is determined as a function of a route traveled by the means of passenger transport between the time the respective person boards and alights the means of passenger transport.

Other payment models provide that the use of the means of passenger transport is not subsequently charged to an account but is paid for in advance. In a corresponding further embodiment, the ticket detection system checks whether the respective ticket is assigned an amount of a means of payment that entitles the passenger to use the means of passenger transport.

In a preferred embodiment, the person detection system is further equipped with at least one sensor. Said sensor detects the persons boarding and alighting the means of passenger transport. The sensor can be arranged, for example, in the area of a door of the means of passenger transport so that its detection range at least partially covers an area that people pass when using the door. Proximity sensors or imaging sensors are suitable for this purpose.

Imaging sensors can also be used for passenger compartment monitoring. In this case, one or more imaging sensors are arranged to detect at least a part of a passenger compartment of the means of passenger transport. By means of the imaging sensors, one or more images of at least a part of the passenger compartment are created. These images are compared with a previously taken image of the empty passenger compartment using the same sensors to identify the people in the passenger compartment. In particular, this detects people boarding and alighting independently of their tickets.

Alternatively, or additionally, in a preferred further embodiment, the persons can be detected by means of at least one axle or wheel load of the means of passenger transport. The axle or wheel load includes not only a weight force component of the means of passenger transport, but also of the persons transported. Preferably, the boarding and alighting of persons is determined by continuous or repeated measurement of the axle or wheel load. If the axle or wheel load changes by an amount that corresponds to the weight of a person, this indicates that the person has boarded or alighted the vehicle. If the axle or wheel load increases, a person has boarded the means of passenger transport. A corresponding reduction in the axle or wheel load indicates that the person has alighted the vehicle.

Preferably, the person detection system is further configured to pinpoint the location of the persons by means of the at least one sensor and/or the at least one axle or wheel load. Determining the person's location is possible in different ways depending on the type of sensor. If it is a door sensor, it can be concluded that the person is in the vicinity of the respective door. The exact location of the person in question can be determined by means of a sensor for interior monitoring. People can also be localized by axle or wheel load, since different wheels are related differently to a change in wheel load depending on where a person is located within the means of passenger transport.

A method according to the invention corresponds to the method described above, carried out by means of the arrangement according to the invention.

### BRIEF DESCRIPTION OF THE DRAWING

A preferred exemplary embodiment of the invention is shown in FIG. 1, the sole FIGURE of the application. In detail, this shows in:

FIG. 1, an arrangement for recognizing fare dodgers.

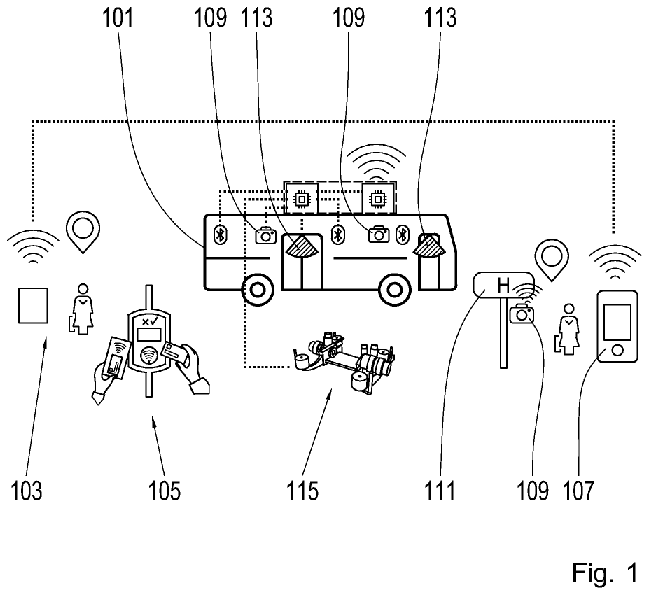

### DETAILED DESCRIPTION

Tickets of passengers of a means of passenger transport 101 can be detected in different ways, for example by means of a BiBo system 103 or a CiCo system 105. It is also possible to identify passengers by means of a mobile end device 107 and/or by means of biometric and/or imaging sensors 109, which are installed in the means of passenger transport 101 and/or at a stop 111. The identified passengers are assigned an electronic ticket in each case, if available.

The systems described only detect tickets. If a fare dodger enters the means of passenger transport 101, he/she is not detected because he/she does not have a ticket. Therefore, the means of passenger transport 101 is equipped with additional sensors that detect passengers independently of their tickets.

In addition to imaging sensors 109, door sensors 113 are also suitable for detecting fare dodgers. These are arranged in such a way that the doors of the means of passenger transport 101 are within the detection range of the sensors 113. Consequently, persons boarding the means of passenger transport 101 and alighting from the means of passenger transport 101 are detected by the door sensors 113.

Similarly, sensors that are commonly present in the chassis 115 of the means of passenger transport 101 may be used to detect the passengers. In particular, these may be pressure and/or altitude sensors of the chassis 115. Depending on the number of persons in the means of passenger transport 101, the parameters detected by these sensors change. Based on this, the number of people can be inferred.

### LIST OF REFERENCE NUMERALS

101 Means of passenger transport
103 BiBo system
105 CiCo system
107 Mobile end device
109 Biometric and/or imaging sensor
111 Stop
113 Door sensor
115 Chassis

1. A system for recognizing persons using a means of passenger transport (101) without a ticket, the system comprising:
a ticket detection system (103, 105) configured to detect tickets of persons boarding and alighting the means of passenger transport;
a person detection system configured to detect passengers independently of tickets when the passengers board and alight the means of transport; and
a comparison means configured to compare a number of tickets detected by the ticket detection system (103, 105) and a number of passengers detected by the person detection system.

2. The system according to claim 1, wherein the ticket detection system (103, 105) is configured to detect an identifier upon boarding and alighting and to debit an amount of a payment means from an account associated with said identifier.

3. The system according to claim 2; wherein the amount is determined as a function of a route traveled between boarding and alighting.

4. The system according to claim 1, wherein the ticket detection system (103, 105) is configured to check whether the ticket is associated with an order of a means of payment entitling to use the means of passenger transport.

5. The system according to claim 1, wherein the person detection system comprises at least one sensor (109, 113) configured to detect passengers boarding and alighting the means of transport.

6. The system according to claim 1, wherein the person detection system is configured to detect the persons by means of at least one axle load or wheel load of the means of passenger transport (101).

7. The system according to claim 5, wherein the person detection system is configured to locate the persons by means of the at least one sensor (109, 113) and/or the at least one axle or wheel load.

8. A method for recognizing persons using a means of passenger transport (101) without a ticket, the method comprising:
detecting tickets of persons during boarding and alighting
detecting persons during boarding and alighting independently of detecting the tickets; and
comparing the number of detected tickets with the number of detected persons.

9. The system according to claim 6, wherein the person detection system is configured to locate the persons by means of the at least one sensor (109, 113) and/or the at least one axle or wheel load.
